(19) United States
(12) Patent Application Publication
(10) Pub. No.: US 2003/0188307 A1
(43) Pub. Date: Oct. 2, 2003

(54) Digital broadcasting receiver

(76) Inventor: Yusuke Mizuno, Kasugai (JP)

Correspondence Address: WENDEROTH, LIND & PONACK, L.L.P., 2033 K STREET N. W., SUITE 800, WASHINGTON, DC, 20006-1021, US

(21) Appl. No.: 10/397,286

(22) Filed: Mar. 27, 2003

(30) Foreign Application Priority Data
Mar. 29, 2002 (JP) 2002-096501

(51) Int. Cl. H04N 7/16

(52) U.S. Cl. 725/28

(57) ABSTRACT

The present invention provides a digital broadcasting receiver capable of providing a user-defined program viewing control, separately from a program viewing control defined by broadcasting stations. For each program to be broadcast by a broadcasting station, a program information memory 22 stores program information including a parental value preset by the broadcasting station and a self-parental value arbitrarily set by the user. When the user gives an instruction for viewing a given program, a program information management section 21 reads out the program information of that program from the program information memory 22. A parental determination section 24 determines whether or not the program should be blocked from being viewed based on the program information (the parental value and the self-parental value) of the program and a reference value preset in the receiver. A control section 20 issues instructions to relevant components so as to allow/block the viewing of the program according to the determination result.

### BACKGROUND OF THE INVENTION

1. Field of the Invention

The present invention relates to a digital broadcasting receiver, and more particularly to a digital broadcasting receiver with a parental control function for selectively blocking some programs to be broadcast from being viewed.

2. Description of the Background Art

With the remarkable advancement of techniques for digitizing and processing various information signals such as video and audio signals, digital broadcasting systems have been developed actively to replace the existing analog broadcasting systems. In a digital broadcasting system, contents such as video and audio contents (hereinafter referred to as “programs”) are broadcast while being multiplexed with program arrangement information called “SI (Service Information)” that includes information on services and programs provided by the digital broadcasting system.

The program arrangement information is data that contains a program list and information on the content of a program, etc., as a program guide, and is used to provide information on the program to the viewer. This data, which is in a table format, is transmitted to the digital broadcasting receiver as one form of information data to be multiplexed with the program. The digital broadcasting receiver uses this data to obtain program information, which is information concerning the program. The program information of a program includes the channel number, the scheduled date and time, the title, the genre, etc., of the program, and the digital broadcasting receiver provides these kinds of information to the viewer in the form of an electronic program guide, for example. The viewer can easily select a program by using the electronic program guide.

Moreover, programs have also been increasing in variety with the increase in the number of channels. Therefore, additional information such as control information for controlling the digital broadcasting receiver according to, for example, the content of the program is also transmitted as part of the program information. One example of such control information is parental information. The parental information is information that is used to make it possible to block viewing of the program on the digital broadcasting receiver side. For example, in a transport stream (TS), which is a typical digital signal, the parental information is written in the first byte of the private data byte area in the conditional access descriptor, which is located in the first loop of a PMT (Program Map Table), as illustrated in FIG. 15. The value “0x00” written in this byte indicates “parental control undefined”, and “0x01” to “0x11” indicate “4” to “20”, respectively, which are threshold age values based on which programs can be blocked from being viewed. Note that a PMT is a kind of PSI (Program Specific Information) describing, for example, the arrangement of a plurality of programs multiplexed together based on the MPEG2 multiplexed signal format, which is defined in the European DVB (Digital Video Broadcasting) standard, and is a table describing detailed information such as the arrangement and the transmission identifier of each program.

Based on such parental information, parental control is performed as follows.

Reference information, which describes a criterion for programs that a user (e.g., a parent) does not wish to permit viewing of (i.e., a reference based on which a universal parental control is performed), is preset in the digital broadcasting receiver. In some cases, authentication information (typically, a password) for overriding the viewing control is also set together with the reference information.

When the user selects a program to view, the digital broadcasting receiver obtains the program information of the program to check the parental information in the program information. Then, the digital broadcasting receiver compares the parental information with the preset reference information to determine whether the program should be blocked from being viewed or not. If the program should be blocked from being viewed, the digital broadcasting receiver blocks the program from being viewed. Note that, if a password has been set, the digital broadcasting receiver prompts the user to enter a password. Only when a valid password is entered does the digital broadcasting receiver “unblock” the program (i.e., so that it can be viewed).

Thus, with the digital broadcasting receiver, some programs can be selectively blocked from being viewed based on the reference information preset in the receiver.

With the conventional digital broadcasting system described above, although whether or not to block a program from being viewed is determined at the digital broadcasting receiver side based on the reference information set by the user, the parental information used for the determination is set by the broadcasting stations. Therefore, the system may not provide a parental control that is optimal for the user because some programs that should really be blocked may not in fact be blocked, and vice versa, depending on how the reference information is set.

In view of this, a digital broadcasting receiver as described in Japanese Laid-Open Patent Publication No. 2001-145033 has been proposed in the art as one approach to solve the problem. The technique described in this publication allows the user to define a viewing control on the digital broadcasting receiver side for programs that are not parentally controlled on the broadcasting station side, i.e., programs for which no parental information has been set by the broadcasting stations.

FIG. 16 is a block diagram illustrating a configuration of the conventional digital broadcasting receiver described in the publication.

Referring to FIG. 16, a tuner 112 receives digital broadcast waves via an antenna 111, and demodulates them into a digital signal. A separation section 113 separates the digital signal demodulated by the tuner 112 into video packets, audio packets and information data, and extracts those of a program to be viewed. The information data includes program information data of each program such as the channel number, the scheduled date and time, the title, etc. A program information management section 121 retrieves the program information data from the information data obtained by the separation section 113, and stores and manages the retrieved program information data in a program information memory 122.

A program list creation section 123 creates program list image data from the program information stored in the program information memory 122, and sends it to a synthesis section 116. A video decoder 114 demodulates the video packets separated by the separation section 113 into video data that can be displayed on a monitor, or the like. The synthesis section 116 synthesizes the program list image data created by the program list creation section 123 with the video data demodulated by the video decoder 114, and outputs the synthesized data. A video output section 117 outputs a video signal according to the supplied video data and drives the monitor, or the like. An audio decoder 115 demodulates the audio packets separated by the separation section 113 into audio data. An audio output section 118 outputs an audio signal according to the audio data from the audio decoder 115 and drives a loudspeaker, or the like.

A condition information memory 126 stores condition information representing the condition for blocking a program specified by the user from being viewed. The condition for blocking a program from being viewed is specified by the user as a combination of channel numbers, time slots, genres, etc., of programs to be blocked from being viewed. When these conditions match the program information of a received program, the program is blocked from being viewed. A user input section 119 accepts, from the user, an instruction to receive a particular program or other instructions regarding the viewing of programs, and passes the instruction to a control section 120. The control section 120 controls the tuner 112, the separation section 113, the program information management section 121, the condition information memory 126, the program list creation section 123, and a program recording/reproduction section 125, according to instructions from the user input section 119.

A display blocking determination section 124 receives, from the program information management section 121, the program information for the program that the user has designated to receive, and compares the program information with the condition information stored in the condition information memory 126. When the program information of the program designated by the user matches the condition information stored in the condition information memory 126, the control section 120 controls the tuner 112 to stop receiving the program designated by the user. Note that if a password has been set, the user can enter the password, etc., to allow the program to be received so that the user can view the program.

The program recording/reproduction section 125 records the video data and the audio data supplied to the video output section 117 and the audio output section 118, respectively, in response to an instruction from the control section 120. Moreover, the program information of the program to be recorded is sent from the program information management section 121, and the program recording/reproduction section 125 records the program information while recording the program. The program recording/reproduction section 125 can reproduce a recorded program, in response to an instruction from the control section 120, by supplying the recorded video data and audio data to the video output section 117 and the audio output section 118, respectively, while supplying the recorded program information to the program information management section 121 and the display blocking determination section 124.

As described above, with the digital broadcasting receiver of the above-identified publication, condition information is set for each program to selectively block or not block the program from being viewed.

However, with the conventional technique described in the above-identified publication, the user is allowed only to control the viewing of those programs for which no parental information has been set by the broadcasting stations, and is not allowed to control the viewing of other programs for which parental information has been set by the broadcasting stations.

Moreover, in a case where the condition information representing the condition for blocking a program from being viewed is stored in the condition information memory 126, as in the conventional technique described in the above-identified publication, the memory area for storing the condition information increases as the number of programs to be blocked from being viewed increases. This necessitates the condition information memory 126 to have a sufficient memory area. Moreover, as the memory area increases, it takes a longer time to determine whether or not a program should be blocked from being viewed, thereby decreasing the response speed.

Particularly, when the program recording/reproduction section 125 is a video cassette recorder (VCR), there are other problems as follows. A video cassette, being a removable recording medium, is normally used for recording/reproduction with more than one VCRs. Moreover, if programs specified to be blocked from being viewed are recorded for long-term storage, a growing number of video cassettes will be required over time. As a result, a memory area for storing condition information that is sufficient for accommodating an increased number of video cassettes will be required, thereby increasing the size of the condition information memory 126.

Furthermore, when there are a plurality of the above-described digital broadcasting receivers, a complicated operation is required to maintain the compatibility therebetween with respect to the viewing control. For example, assume a case where a program blocked from being viewed is recorded in a video cassette by one digital broadcasting receiver, and then reproduced from the video cassette by another digital broadcasting receiver. In such a case, since the latter digital broadcasting receiver does not have the condition information for the video cassette, it may play the video cassette normally, i.e., failing to block the recorded program from being viewed. This can be avoided by again inputting, at the latter digital broadcasting receiver, the condition information for programs recorded in the video cassette that should be blocked from being viewed, which can be very time-consuming.

### SUMMARY OF THE INVENTION

Therefore, an object of the present invention is to provide a digital broadcasting receiver capable of solving the problems set forth above by providing and managing, for each program, parental information that can be arbitrarily set and changed by the user, separately from parental information that is specified by a broadcasting station.

The present invention has the following features to attain the object mentioned above.

A first aspect of the present invention is directed to a digital broadcasting receiver for receiving and processing a digital broadcasting signal from a broadcasting station, the digital broadcasting signal being obtained by multiplexing at least a program and parental information that specifies a viewing control set by the broadcasting station for the program.

The digital broadcasting receiver of the first aspect includes: a receiving section for receiving the digital broadcasting signal; a decoding section for decoding the received digital broadcasting signal into the program and the parental information; a user input section for receiving self-parental information entered by a user for each program, the self-parental information specifying a viewing control arbitrarily set by the user for the program; an information storage section in which program information including the parental information and the self-parental information for each program is previously stored in association with the program, for at least some of programs that are currently being broadcast or will be broadcast; a parental control section for determining, for each program, whether the program should be blocked from being viewed or allowed to be viewed based on reference information preset in the receiver by the user and the program information; and a program processing section for showing or not showing the program based on the determination by the parental control section.

In accordance with the digital broadcasting receiver of the first aspect having such a configuration, in response to an instruction from the user to show a received program, the parental control section obtains the program information of the received program from the information storage section, and determines whether the received program should be blocked from being viewed or allowed to be viewed based on whether or not the obtained program information satisfies the reference information; and the program processing section shows the received and decoded program when the parental control section determines that the program should be allowed to be viewed.

As described above, in the first aspect, the self-parental information that can be arbitrarily set/changed by the user is stored in the information storage section for each program, separately from the parental information assigned to the program by the broadcasting station. Then, when there is a request to view a program, the self-parental value for the program is used to determine whether or not the program should be blocked from being viewed. Thus, it is possible to realize a parental control that reflects the intention of the user of the receiver.

Particularly, the self-parental value is stored as a part of the program information in the program information memory, whereby it is not necessary to additionally provide a memory, or the like, in the receiver for storing data for the parental determination. Note that since the program information for programs that have been broadcast may be erased from the program information memory, the need to provide a large memory for the program information can be eliminated by erasing the program information for each program at the end of the broadcasting of the program.

Typically, the parental control section determines that the received program should be allowed to be viewed if the self-parental information satisfies the reference information. Where the self-parental information does not satisfy the reference information, the parental control section may determine that the received program should be allowed to be viewed if the parental information satisfies the reference information.

Conversely, the parental control section may first determine that the received program should be allowed to be viewed if the parental information satisfies the reference information; and then, where the parental information does not satisfy the reference information, the parental control section may determine that the received program should be allowed to be viewed if the self-parental information satisfies the reference information.

Thus, various parental controls can be realized by freely combining the parental information with the self-parental information.

Moreover, where the self-parental information does not satisfy the reference information, the parental control section may prompt the user to enter a predetermined password and determine that the received program should be allowed to be viewed if the predetermined password is entered. Furthermore, where the parental information does not satisfy the reference information, the parental control section may prompt the user to enter a predetermined password and determine that the received program should be allowed to be viewed if the predetermined password is entered.

Alternatively, where the parental information and the self-parental information are both set, the parental control section may prompt the user to enter two predetermined passwords and determine that the received program should be allowed to be viewed if the two predetermined passwords are entered.

Thus, by presetting a password with which the blocking of the viewing of a program can be overridden, a particular user who knows the password can still view a program that is otherwise blocked from being viewed.

Moreover, it is preferred that the parental information, the self-parental information and the reference information are each an age value determined based on an age or ages of viewers who should be allowed to view a program.

By using the simple age value, the user can easily set a program viewing control.

A second aspect of the present invention is directed to the digital broadcasting receiver of the first aspect, further including a program recording/reproduction section, wherein: in response to an instruction from the user to record a program received by the receiving section, the program recording/reproduction section records, on a recording medium, the received program together with the program information for the program, which is previously stored in the information storage section; and in response to an instruction from the user to reproduce a recorded program, the program recording/reproduction section reproduces the program information for the recorded program from the recording medium, and reproduces the recorded program from the recording medium when the parental control section determines that the recorded program should be allowed to be viewed.

As described above, in the second aspect, the program information stored in the information storage section is recorded on the recording medium together with the program, whereby a program that has been recorded by the program recording/reproduction section can be reproduced selectively based on the program information. Therefore, it is possible to reliably and easily realize a parental control that reflects the intention of the user who recorded the program.

It is preferred that the recording medium on/from which the program and the program information are recorded/reproduced by the program recording/reproduction section is a removable recording medium.

Thus, by recording the self-parental information of each recorded program on a removable recording medium, it is possible to realize a level of compatibility that allows for a parental control based on the self-parental information with any other receivers.

Typically, the program recording/reproduction section records, on the recording medium, a partial transport stream obtained by multiplexing at least the program and the program information. In such a case, the program recording/reproduction section may write the parental information and the self-parental information in at least one of a SIT and a PMT allocated in the partial transport stream. Particularly, if the program information is written in a PMT, it is possible to prevent a part of a parentally-blocked program from being viewed before a SIT is first detected in the reproduction operation.

It is more preferred that the program recording/reproduction section further records the parental information and the self-parental information in a header area on the recording medium for managing a data area where the partial transport stream is recorded.

Thus, if the parental information and the self-parental information are further recorded in a predetermined header, it is possible to effectuate a parental control at the start of the reproduction of a program without delay.

Note that an arithmetic expression for obtaining the parental information and the self-parental information may alternatively be recorded in the header area.

Thus, if the program information is recorded by using an arithmetic expression, it is possible to reduce the total amount of information to be recorded.

In the second aspect, in response to an instruction from the user to reproduce a specific program recorded on the recording medium, the program recording/reproduction section reproduces the program information of the specific program from the recording medium; the parental control section obtains the reproduced program information from the program recording/reproduction section, and determines whether the specific program should be blocked from being viewed or allowed to be viewed based on the program information; the program recording/reproduction section reproduces the specific program from the recording medium when the parental control section determines that the specific program should be allowed to be viewed; and the program processing section shows the specific program reproduced by the program recording/reproduction section.

With this process, the user can perform a program reproduction operation under an intended viewing control by using the program information recorded on the recording medium.

In the reproduction operation, the parental control section determines that the reproduced program should be allowed to be viewed if the self-parental information of the reproduced program satisfies the reference information. Where the self-parental information does not satisfy the reference information, the parental control section may prompt the user to enter a predetermined password and determine that the reproduced program should be allowed to be viewed if the predetermined password is entered.

Moreover, in the second aspect, the user input section further receives, from the user, a search condition set by the user; in response to an instruction from the user to search for a program recorded on the recording medium, the program recording/reproduction section reproduces from the recording medium the program information for all programs recorded thereon; and the parental control section obtains all of the reproduced program information from the program recording/reproduction section, and searches, based on all of the program information, for a program or programs whose program information matches the search condition.

With this process, the user can perform a program search operation under an intended viewing control by using the program information recorded on the recording medium.

In the search operation, the parental control section may exclude any of the found program or programs if the self-parental information thereof does not satisfy the reference information. Moreover, where the self-parental information of any found program does not satisfy the reference information, the parental control section may prompt the user to enter a predetermined password and may not exclude the program if the predetermined password is entered.

Moreover, in the second aspect, the user input section further receives, from the user, a search condition set by the user; in response to an instruction from the user to search for and reproduce a program recorded on the recording medium, the program recording/reproduction section reproduces from the recording medium the program information for all programs recorded thereon; the parental control section obtains all of the reproduced program information from the program recording/reproduction section, and searches, based on all of the program information, for a program or programs whose program information matches the search condition; the program recording/reproduction section reproduces, from the recording medium, each program found by the parental control section; and the program processing section shows the program reproduced by the program recording/reproduction section.

With this process, the user can perform a program search operation and a program reproduction operation under an intended viewing control by using the program information recorded on the recording medium.

In the search/reproduction operation, the parental control section may exclude any of the found program or programs if the self-parental information thereof does not satisfy the reference information. Moreover, where the self-parental information of any found program does not satisfy the reference information, the parental control section may prompt the user to enter a predetermined password and may not exclude the program if the predetermined password is entered.

It is preferred that the self-parental information and the reference information are each an age value determined based on an age or ages of viewers who should be allowed to view a program.

By using the simple age value, the user can easily set a program viewing control.

Note that in the second aspect, the user input section may further receive, from the user, predetermined information indicating a program content set by the user; the information storage section may store the program information including the predetermined information; and the program recording/reproduction section may record the program information including the predetermined information on the recording medium.

The user input section may further receive, from the user, a search condition and a specified condition which are set by the user; in response to an instruction from the user to search for a program recorded on the recording medium, the program recording/reproduction section may reproduce from the recording medium the program information for all programs recorded thereon; and the parental control section may obtain all of the reproduced program information from the program recording/reproduction section, and search, based on all of the program information, for a program or programs whose program information matches the search condition and the specified condition.

Thus, by using the predetermined information, which is different from the parental information, it is possible to realize a complex parental control.

Typically, the parental control section searches for a program or programs whose predetermined information satisfies the specified condition and whose self-parental value satisfies the reference information. Where the self-parental information of a program does not satisfy the reference information, the parental control section may prompt the user to enter a predetermined password and include the program as an object of the search if the predetermined password is entered.

Moreover, the program recording/reproduction section records, on the recording medium, a partial transport stream obtained by multiplexing at least the program and the program information. In such a case, the program recording/reproduction section may describe the parental information and the self-parental information in at least one of a SIT and a PMT allocated in the partial transport stream. Particularly, if the program information is written in a PMT, it is possible to prevent a part of a parentally-blocked program from being viewed before a SIT is first detected in the reproduction operation.

Moreover, it is preferred that the predetermined information is defined in advance by using unused bits of an area where the parental information is written, so that the present invention can be realized without changing standard specifications.

A third aspect of the present invention is directed to the digital broadcasting receiver of the first aspect, wherein the receiving section further has a function of receiving, from a broadcasting station, an analog broadcasting signal obtained by modulating a carrier with data concerning analog broadcast programs, and the decoding section further has a function of converting the analog broadcasting signal into a digital signal.

In accordance with the digital broadcasting receiver of the third aspect with these additional functions, in the information storage section, the self-parental information obtained from the user input section for each of at least some of the analog broadcast programs that are currently being broadcast or will be broadcast is previously stored in association with the program; in response to an instruction from the user to show an analog broadcast program, the parental control section obtains the self-parental information for the analog broadcast program from the information storage section, and determines whether the analog broadcast program should be blocked from being viewed or allowed to be viewed based on the self-parental information; and the program processing section shows the analog broadcast program when the parental control section determines that the analog broadcast program should be allowed to be viewed.

Thus, the digital broadcasting receiver is capable of handling analog broadcasting signals carrying no parental control information, in addition to digital broadcasting signals.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of a digital broadcasting receiver according to a first embodiment of the present invention;

FIG. 2 and FIG. 3 are diagrams each illustrating an example of program information stored in a program information memory;

FIG. 4 is a flowchart illustrating a procedure for setting/changing a self-parental value according to the first embodiment of the present invention;

FIG. 5 is a flowchart illustrating a procedure for showing a program according to the first embodiment of the present invention;

FIG. 6 to FIG. 8 are flowcharts each illustrating a procedure for making a determination whether or not a program should be blocked from being viewed, which is performed in step S507 of FIG. 5;

FIG. 9 is a block diagram illustrating a configuration of a digital broadcasting receiver according to a second embodiment of the present invention;

FIG. 10 is a flowchart illustrating a procedure of a program recording operation according to the second embodiment of the present invention;

FIG. 11 is a flowchart illustrating a procedure of a program reproduction operation according to the second embodiment of the present invention;

FIG. 12 is a diagram illustrating an area of a partial transport stream where a parental set is written;

FIG. 13 is a flowchart illustrating a procedure of a program search operation according to a third embodiment of the present invention;

FIG. 14 is a flowchart illustrating a procedure of a program editing operation according to the third embodiment of the present invention;

FIG. 15 is a schematic diagram illustrating a data structure of a transport stream; and

FIG. 16 is a block diagram illustrating a configuration of a conventional digital broadcasting receiver.

### DESCRIPTION OF THE PREFERRED EMBODIMENTS

A digital broadcasting receiver of the present invention may be integrated with a television receiver, etc., including a video monitor and an audio speaker, or may alternatively be in the form of a set-top box (STB), or the like, that is separate from a television receiver, etc.

The present invention will now be described with respect to a case where the digital broadcasting receiver is in the form of a set-top box and processes received program data in the transport stream format.

(First Embodiment)

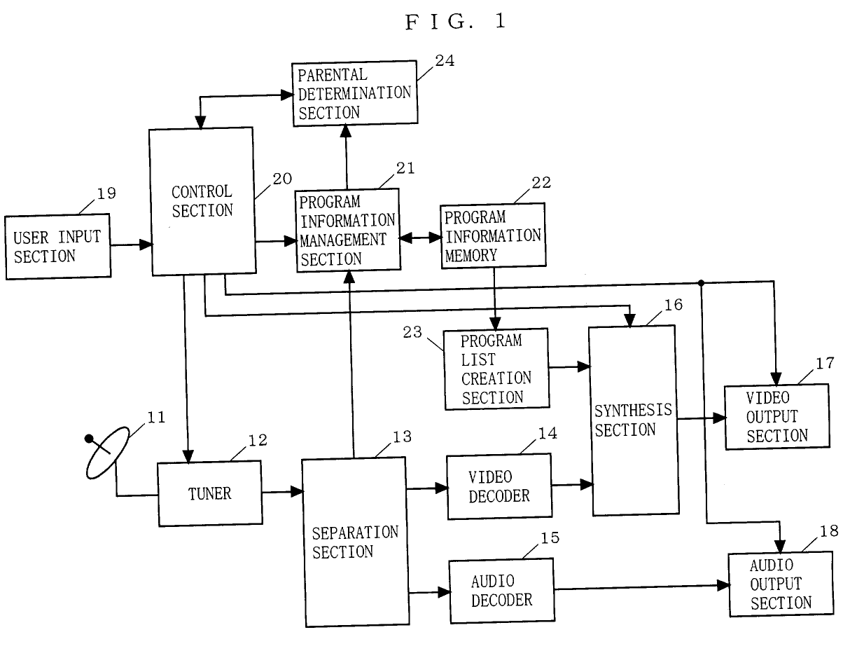

FIG. 1 is a block diagram illustrating a configuration of a digital broadcasting receiver according to the first embodiment of the present invention. Referring to FIG. 1, the digital broadcasting receiver of the first embodiment includes an antenna 11, a tuner 12, a separation section 13, a video decoder 14, an audio decoder 15, a synthesis section 16, a video output section 17, an audio output section 18, a user input section 19, a control section 20, a program information management section 21, a program information memory 22, a program list creation section 23, and a parental determination section 24.

The tuner 12, the separation section 13, the video decoder 14 and the audio decoder 15 together constitute a receiving section and a decoding section. The control section 20, the program information management section 21 and the parental determination section 24 together constitute a parental control section. The video output section 17 and the audio output section 18 together constitute a program processing section.

First, the components of the digital broadcasting receiver according to the first embodiment of the present invention will be described briefly.

The tuner 12 receives digital broadcast waves of a channel that broadcasts the program designated by the user via the antenna 11. Then, the tuner 12 performs a demodulating operation, an error correction operation, etc., on the received digital broadcast waves to output a digital signal in the transport stream format. The separation section 13 divides the transport stream outputted from the tuner 12 into TS packets and retrieves, from the TS packets, video packets, audio packets and other information data (including control information such as PSI and SI) of the program designated by the user. The retrieved video packets, audio packets and information data are supplied to the video decoder 14, the audio decoder 15 and the program information management section 21, respectively. More specifically, the packets are supplied to the decoders after being converted into fixed-rate streams via a FIFO memory (not shown) for performing a first-in first-out operation.

The video decoder 14 decodes the video packets separated by the separation section 13 into video data. The audio decoder 15 decodes the audio packets separated by the separation section 13 into audio data. The synthesis section 16 either outputs one of the video data decoded by the video decoder 14 and the program list image data created by the program list creation section 23, or outputs data obtained by synthesizing the video data with the program list image data. The video output section 17 converts the data outputted from the synthesis section 16 into a video signal that can be displayed on a monitor, or the like. The audio output section 18 converts the audio data outputted from the audio decoder 15 into an audio signal that can be outputted from a loudspeaker, or the like. The converted video signal and audio signal are outputted to an external device.

The user input section 19, which may be a remote control, for example, receives and passes various instructions from the user (a program selection instruction, a program list display instruction, a parental control instruction, etc.) to the control section 20. The control section 20 controls the tuner 12, the separation section 13, the synthesis section 16, the video output section 17, the audio output section 18, the program information management section 21 and the parental determination section 24 by providing instructions for program reception, setting/changing of program information, viewing control, program list display, etc. The program information management section 21 selectively obtains program information data for the program from the information data retrieved by the separation section 13, and stores and manages the program information obtained from the program information data in the program information memory 22. Moreover, the program information management section 21 assigns self-parental information, which is to be described later, to each program stored in the program information memory 22, in response to an instruction from the user. The digital broadcasting receiver of the present embodiment performs operations such as the provision of the program information and the blocking of received programs by using the program information and the self-parental information.

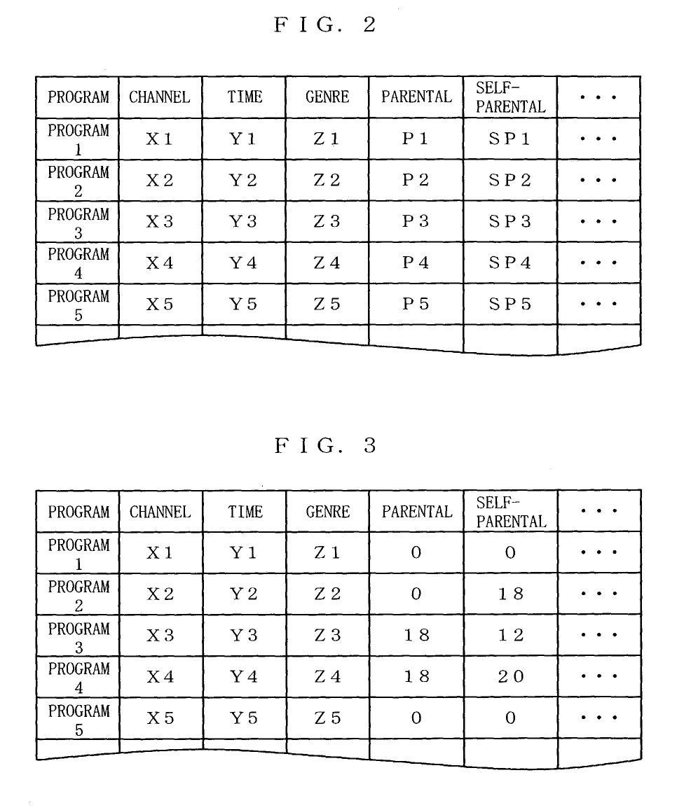

The program information memory 22 stores the program information and the self-parental information from the program information management section 21 (FIG. 2). The program information includes the channel number, the scheduled date and time, the title, the genre, the parental information for viewing control, etc., for each program. The self-parental information is parental control information that can be arbitrarily set by the user, and is different from the parental information, which is provided from broadcasting stations while being contained in the program information. Note that program information used in digital broadcasting includes short-term program information for the program currently being broadcast and the following program, and long-term program information for programs for about one week. Thus, the program information memory 22 stores both the short-term program information and the long-term program information. The program list creation section 23 creates the program list image data based on the program information stored in the program information memory 22, and supplies it to the synthesis section 16. More specifically, the created program list image data is once written in a video memory (not shown), and is read out by the synthesis section 16 from the video memory to display a program list.

The parental determination section 24 stores the reference information, which is preset in the digital broadcasting receiver. The parental determination section 24 determines whether or not the program to be viewed by the user is a program that should be blocked from being viewed (parentally blocked) based on the reference information, and the parental information and the self-parental information in the program information stored in the program information memory 22. In the present embodiment, the program blocking operation is performed based on the determination made by the parental determination section 24.

In an actual device configuration for processing a transport stream, the separation section 13 may be (without limitation) a TS decoder, and the control section 20, the program information management section 21, the program list creation section 23 and the parental determination section 24 may be implemented by a program for performing these functions and a CPU executing the program. Data, information and instructions are exchanged between these components via a data bus.

A method for blocking a program from being viewed according to the first embodiment will now be described in detail.

Note that for an easier understanding of the parental control function of the present invention, the embodiments of the present invention will be described with respect to a case where the parental information, the self-parental information and the reference information are each a value that represents a critical age of viewers who will be “parentally blocked” from viewing a program. Note also that the term “parental set” may be used to refer to a set consisting of a parental value and a self-parental value.

First, the program information management section 21 needs to obtain, from the information data, the program information to be stored and managed in the program information memory 22. For example, the program information is obtained as follows. When the user turns ON the digital broadcasting receiver, the control section 20 instructs the tuner 12 to catch a transport stream including long-term program information. In response to the instruction, the tuner 12 catches the transport stream. The program information management section 21 obtains the latest long-term program information from the transport stream via the separation section 13, and stores it in the program information memory 22. If there exists program information stored in the program information memory 22, the program information management section 21 updates the program information with the latest long-term program information.

In this operation, the program information memory 22 is updated as follows with respect to the parental values included in the program information. The parental values are not updated for those programs for which the parental values are not specified (i.e., programs that are not parentally blocked) in the latest long-term program information. Therefore, if parental values for those programs are already stored based on the previously-obtained long-term program information, the previous parental values are retained unchanged. For each program that is parentally blocked, the specified parental value is stored to update the memory. In this operation, if a parental value is already stored based on the previously-obtained long-term program information, one of the existing parental value and the specified parental value that is of a stronger (i.e., more strict) or weaker (i.e., less strict) parental blocking level is stored in the memory. Thus, the latest program information for programs for about one week from the present time is stored in the program information memory 22. Note that parental values are set/changed similarly for the short-term program information.

Then, the user sets a self-parental value (indicating how the user wishes to block a program) for each program, separately from the parental value provided by a broadcasting station. The self-parental value is arbitrarily defined by the user in view of the title, the content, etc., of the program information. For example, if the program has some adult-oriented contents and the user wishes to block the program from being viewed by those who are eighteen of age or younger, the self-parental value of the program is set to be “18”. Moreover, for a program that does not need to be blocked from being viewed, a self-parental value of “0” is set, which means the program is blocked from being viewed by those who are zero of age or younger. If the self-parental value of a program is not set by the user, it is set to be “0” by default. Note that after setting a self-parental value, the self-parental value can be changed as necessary.

FIG. 3 is a diagram illustrating a specific example of program information in which self-parental values are set according to the setting method described above. Referring to FIG. 3, Program 1 and Program 5 are not blocked from being viewed. Program 2 is not blocked on the broadcasting station side but is blocked by the user from being viewed by those who are eighteen of age or younger. Program 3 is blocked on the broadcasting station side from being viewed by those who are eighteen of age or younger, but the restriction is loosened by the user so that it is only blocked from being viewed by those who are twelve of age or younger. Program 4 is blocked on the broadcasting station side from being viewed by those who are eighteen of age or younger, but the restriction is tightened by the user so that it is blocked from being viewed by those who are twenty of age or younger.

It is preferred that the self-parental value can be set/changed only by a privileged user. This can be achieved by, for example, using authentication information such as a password. For example, a password that is required for setting/changing a self-parental value may be preset. Then, the user is prompted to enter the password when setting/changing a self-parental value via the user input section 19. Thus, only the privileged user who knows the password can set/change the self-parental value. The password may be stored in the control section 20.

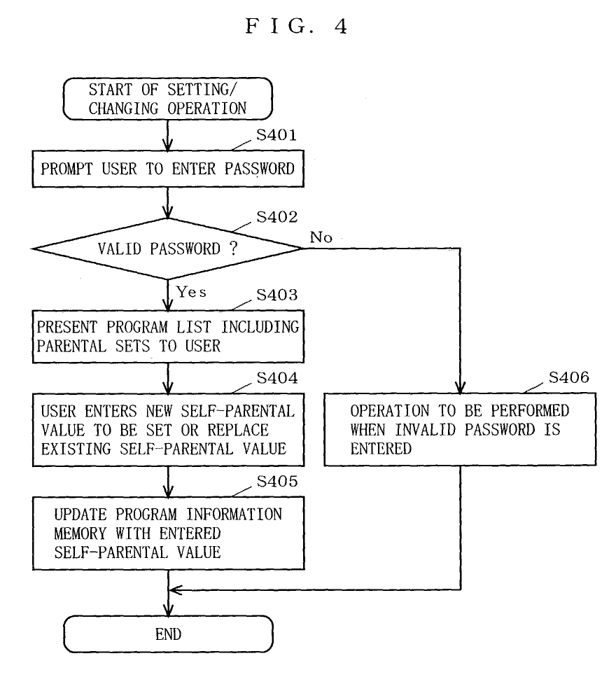

FIG. 4 is a flowchart illustrating the procedure for setting/changing a self-parental value using a password. When the user gives the control section 20 an instruction for setting/changing a self-parental value via the user input section 19, the control section 20 prompts the user to enter a password (step S401). The control section 20 determines whether or not the password entered by the user is valid (step S402). If the entered password is valid, the control section 20 determines that the user is the privileged user, and instructs the program list creation section 23, the synthesis section 16 and the video output section 17 to create and display a program list with parental sets on an external monitor (step S403). The privileged user enters a new self-parental value while looking at the program list displayed on the monitor to instruct the control section 20 to set/change a self-parental value (step S404). The control section 20 updates the program information memory 22 with the new self-parental value according to the instruction (step S405). If the entered password is invalid, the control section 20 determines that the user is not the privileged user, and exits the self-parental value setting/changing operation after an operation to be performed when an invalid password is entered (step S406).

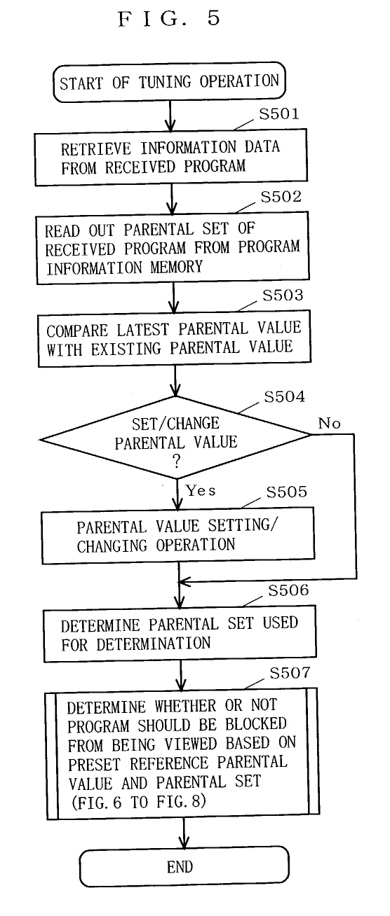

Next, a program showing operation based on a parental set will be described. FIG. 5 is a flowchart illustrating a procedure for showing a program. When the user instructs the control section 20 to show a program, the control section 20 instructs the tuner 12 to receive the program, and instructs the separation section 13 to retrieve the information data from the received program (step S501). Moreover, the control section 20 instructs the program information management section 21 to pass the parental set for the program specified by the user to the parental determination section 24. In response to the instruction, the program information management section 21 reads out a recorded parental set from the program information memory 22 (step S502). The program information management section 21 obtains the program information data from the information data retrieved from the separation section 13, and compares the latest parental value with the existing parental value read out from the program information memory 22 (step S503). If the latest parental value is different from the existing parental value and it is necessary to set or change the parental value, the program information management section 21 performs the above operation of setting/changing a parental value (steps S504 and S505). Finally, the program information management section 21 passes the parental value, which has been set/changed as necessary, and an existing self-parental value to the parental determination section 24 (step S506).

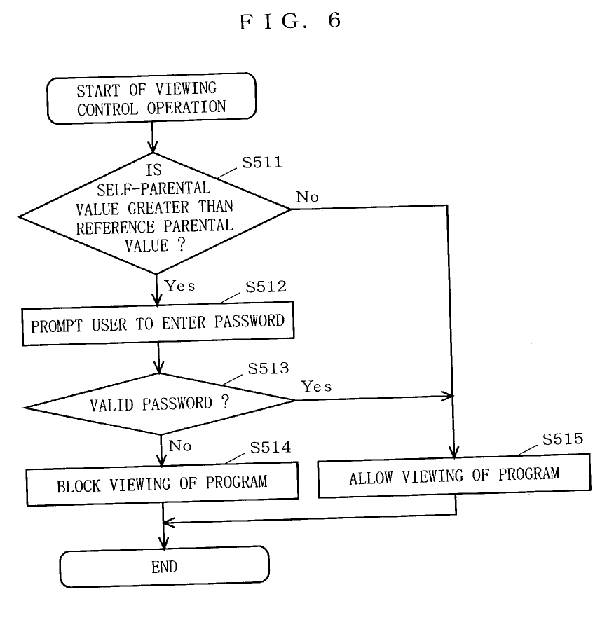

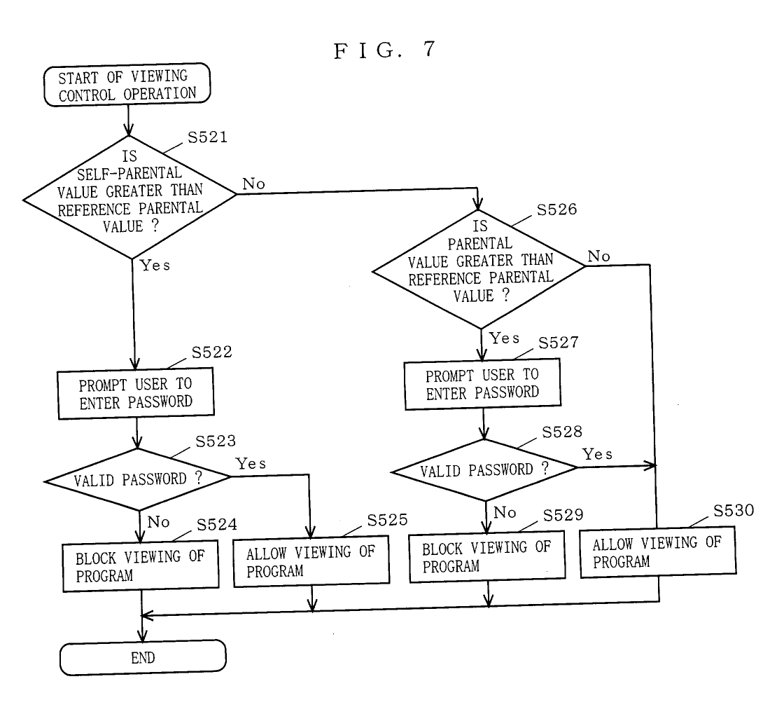

The parental determination section 24 and the control section 20 determine whether or not the program should be blocked from being viewed based on the parental set from the program information management section 21 and a preset reference value (step S507). There are three possible methods for making the determination, as shown in FIG. 6 to FIG. 8, which are flowcharts each illustrating a procedure for determining whether or not a program should be blocked from being viewed.

1. Method Based Only on Self-Parental Value (FIG. 6)

The parental determination section 24 compares the reference value with the self-parental value (step S511). If the self-parental value is greater than the reference value, the control section 20 prompts the user to enter a password (step S512). If the entered password is valid, the control section 20 gives predetermined instructions to relevant components so as to allow the viewing of the program (steps S513 and S515). If the entered password is invalid, the control section 20 gives predetermined instructions to relevant components so as to block the viewing of the program (steps S513 and S514). If the self-parental value is less than the reference value, the control section 20 gives predetermined instructions to relevant components so as to allow the viewing of the program (step S515).

2. Method Based on Self-Parental Value (Higher Priority) and Parental Value (FIG. 7)

The parental determination section 24 compares the reference value with the self-parental value (step S521). If the self-parental value is greater than the reference value, the control section 20 prompts the user to enter a password (step S522). If the entered password is valid, the control section 20 gives predetermined instructions to relevant components so as to allow the viewing of the program (steps S523 and S525). If the entered password is invalid, the control section 20 gives predetermined instructions to relevant components so as to block the viewing of the program (steps S523 and S524).

If the self-parental value is less than the reference value, the parental determination section 24 then compares the reference value with the parental value (step S526). If the parental value is greater than the reference value, the control section 20 prompts the user to enter a password (step S527). If the entered password is valid, the control section 20 gives predetermined instructions to relevant components so as to allow the viewing of the program (steps S528 and S530). If the entered password is invalid, the control section 20 gives predetermined instructions to relevant components so as to block the viewing of the program (steps S528 and S529) If the parental value is less than the reference value, the control section 20 gives predetermined instructions to relevant components so as to allow the viewing of the program (step S530).

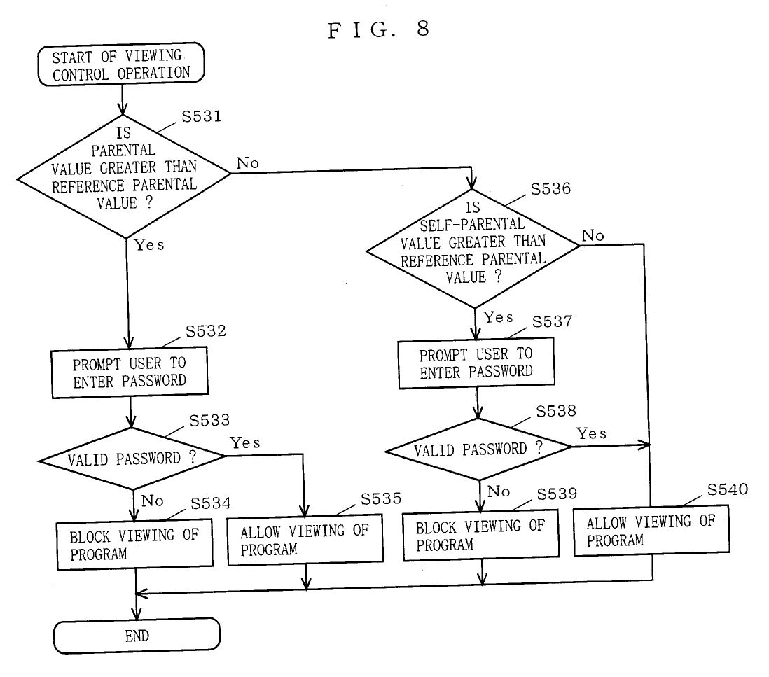

3. Control Based on Self-Parental Value and Parental Value (Higher Priority) (FIG. 8)

The parental determination section 24 compares the reference value with the parental value (step S531). If the parental value is greater than the reference value, the control section 20 prompts the user to enter a password (step S532). If the entered password is valid, the control section 20 gives predetermined instructions to relevant components so as to allow the viewing of the program (steps S533 and S535). If the entered password is invalid, the control section 20 gives predetermined instructions to relevant components so as to block the viewing of the program (steps S533 and S534) If the parental value is less than the reference value, the control section 20 gives predetermined instructions to relevant components so as to allow the viewing of the program (step S535).

If the parental value is less than the reference value, the parental determination section 24 then compares the reference value with the self-parental value (step S536). If the self-parental value is greater than the reference value, the control section 20 prompts the user to enter a password (step S537). If the entered password is valid, the control section 20 gives predetermined instructions to relevant components so as to allow the viewing of the program (steps S538 and S540). If the entered password is invalid, the control section 20 gives predetermined instructions to relevant components so as to block the viewing of the program (steps S538 and S539) If the self-parental value is less than the reference value, the control section 20 gives predetermined instructions to relevant components so as to allow the viewing of the program (step S540).

As described above, with the digital broadcasting receiver according to the first embodiment of the present invention, the self-parental value that can be arbitrarily set/changed by the user is stored for each program in the program information memory 22, separately from the parental value that is assigned to the program by the broadcasting station. Then, when there is a request to show a program, the self-parental value for the program is used to determine whether or not the program should be blocked from being viewed. Thus, it is possible to realize a parental control that reflects the intention of the user of the receiver.

Particularly, the self-parental value is stored as a part of the program information in the program information memory 22, whereby it is not necessary to additionally provide a memory, or the like, in the receiver for storing data for the parental determination. Note that since the program information for programs that have been broadcast may be erased from the program information memory 22, the need to provide a large memory for the program information can be eliminated by erasing the program information for each program at the end of the broadcasting of the program.

Note that in the first embodiment, the user is prompted to enter a password depending on the result of the comparison between the reference value and the parental value or the self-parental value, which is done as part of the operation of determining whether or not a program should be blocked from being viewed at the parental determination section 24 and the control section 20. Alternatively, the user may be unconditionally prompted to enter a password, irrespective of the reference value, as long as there is a parental set for viewing control (i.e., as long as either the parental value or the self-parental value is set). Thus, it is possible to use two passwords to doubly lock the viewing of a program, in which case the program will not be viewed by an unintended viewer even if one of the passwords is revealed.

(Second Embodiment)

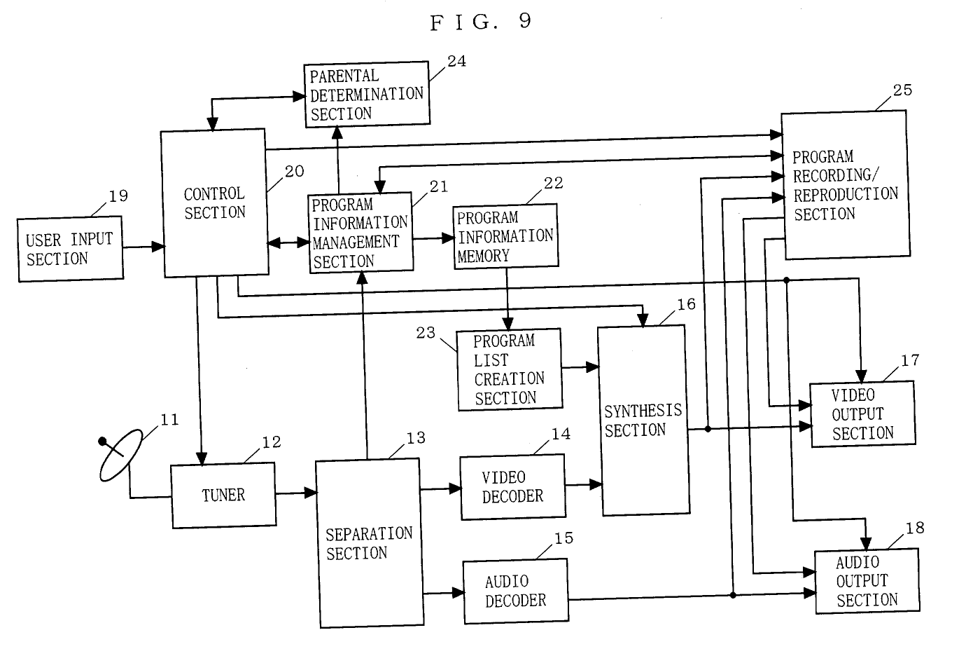

FIG. 9 is a block diagram illustrating a configuration of a digital broadcasting receiver according to the second embodiment of the present invention. Referring to FIG. 9, the digital broadcasting receiver of the second embodiment includes the antenna 11, the tuner 12, the separation section 13, the video decoder 14, the audio decoder 15, the synthesis section 16, the video output section 17, the audio output section 18, the user input section 19, the control section 20, the program information management section 21, the program information memory 22, the program list creation section 23, the parental determination section 24, and a program recording/reproduction section 25.

As can be seen from FIG. 9, the only difference between the configuration of the digital broadcasting receiver of the second embodiment and that of the first embodiment is the provision of the program recording/reproduction section 25 in the second embodiment. The digital broadcasting receiver of the second embodiment is characterized in that the self-parental value, in addition to the parental value, is assigned to each program recorded on a recording medium so as to provide a parental control that reflects the intention of the user when reproducing the recorded program.

The digital broadcasting receiver of the second embodiment will now be described while focusing on the program recording/reproduction section 25, which is characteristic of the second embodiment.

First, a brief description of the program recording/reproduction section 25 will be provided.

The program recording/reproduction section 25 has a function of driving a removable recording medium such as a video cassette or a DVD-RAM or a fixed recording medium such as a hard disk. In response to an instruction from the control section 20 to record a program, the program recording/reproduction section 25 receives the video data, the audio data and the program information of the program from the video decoder 14, the audio decoder 15 and the program information management section 21, respectively, and records the data and information on a recording medium in a predetermined format. In the case of a recording format that supports a transport stream, a partial transport stream is recorded. In response to an instruction from the control section 20 to reproduce a program, the program recording/reproduction section 25 reads out the video data, the audio data and the program information of the program from the recording medium, and supplies the data and information to the video output section 17, the audio output section 18 and the program information management section 21, respectively, so as to reproduce the program under a parental control based on the program information.

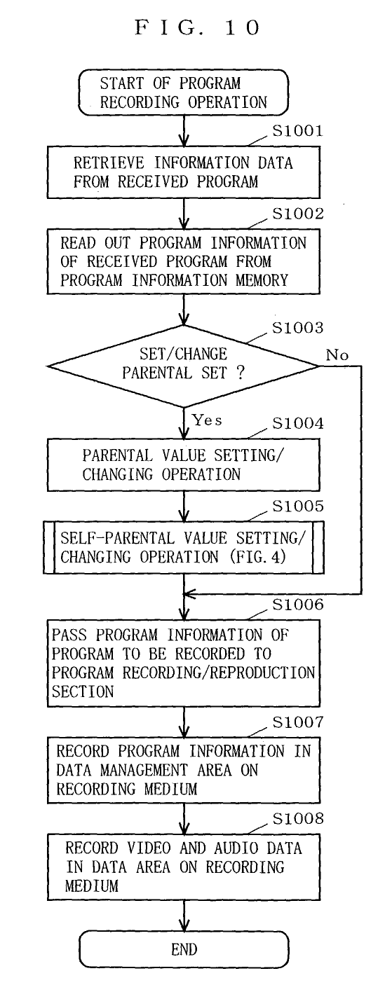

Next, the operation in which a program designated by the user is recorded on the recording medium by the program recording/reproduction section 25 will be described. FIG. 10 is a flowchart illustrating the procedure of the program recording operation.

When the user wishes to record the program currently being received, the user instructs the control section 20 via the user input section 19 to record the program. Note that where the user has set a scheduled recording for a program to be broadcast later, a recording scheduling section (not shown) instructs the control section 20 to record the program at the scheduled time.

The control section 20 instructs the separation section 13 to retrieve the information data from the program to be recorded that is received by the tuner 12 (step S1001). Moreover, the control section 20 instructs the program information management section 21 to pass the program information of the program to be recorded to the program recording/reproduction section 25. In response to the instruction, the program information management section 21 reads out recorded program information from the program information memory 22 (step S1002). As necessary, the user may set/change the parental set (step S1003). As described above, the setting/changing of the parental value is performed based on the comparison between the latest parental value retrieved from the information data, which is retrieved by the separation section 13, and the existing parental value read out from the program information memory 22 (step S1004). The setting/changing of the self-parental value is performed according to the procedure described above in the first embodiment (FIG. 4) (step S1005). Finally, the program information management section 21 passes the program information including a parental set that has been set/changed as necessary to the program recording/reproduction section 25 (step S1006).

First, the program recording/reproduction section 25 records the received program information including the parental set in a predetermined data management area of the area on the recording medium where the program is to be recorded (step S1007). In the case of a partial transport stream recording format, the program information is written in a SIT (Selection Information Table). Then, the program recording/reproduction section 25 records the video data and the audio data of the program to be recorded in a predetermined data area on the recording medium in a predetermined format (step S1008). Thus, the program designated by the user is recorded.

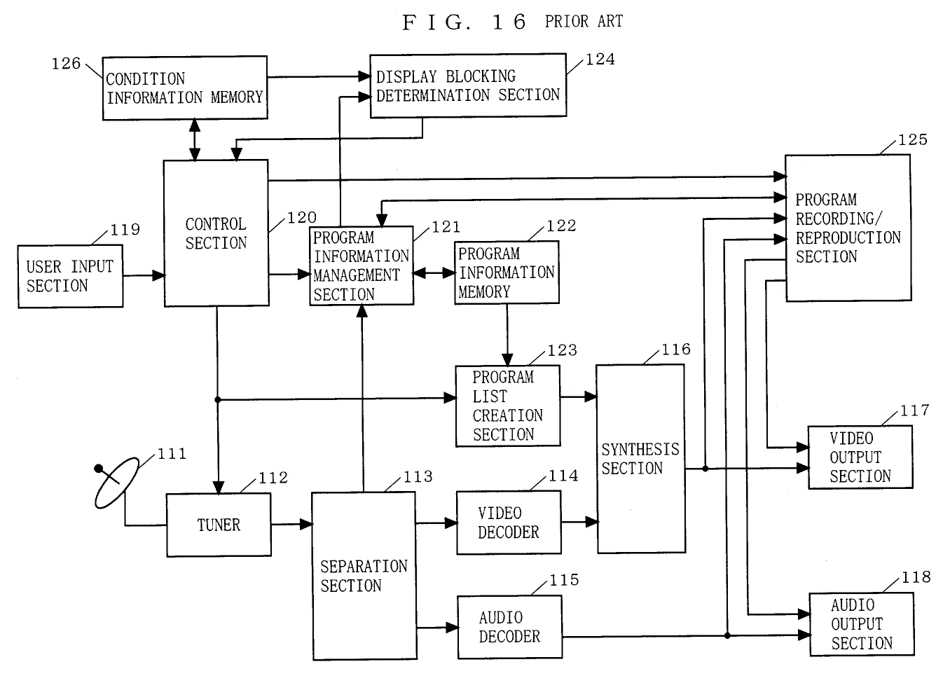

As described above, in a transport stream, the first byte of the private data byte area in the conditional access descriptor is allocated for the parental value (see FIG. 15). In a partial transport stream, the private data byte area is provided in the parental rate descriptor of a SIT. The rest of the private data byte area following the first byte is not at present defined by a standard and can be used freely.

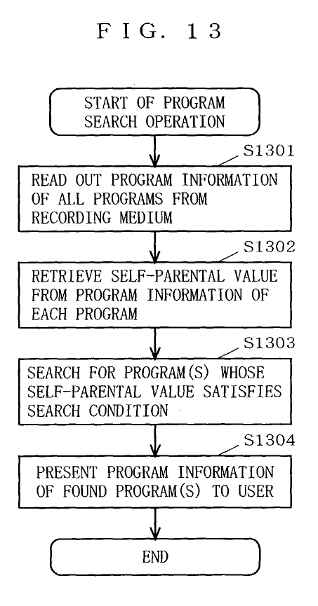

In view of this, according to the present invention, the self-parental value is written in a one-byte area following the first byte in the private data byte area of a partial transport stream where the parental value is written (FIG. 12).

Note that if the parental set is written only in SITs as described above, a part of a parentally-blocked program may possibly be viewed before a SIT is first detected in the reproduction operation. In order to prevent such a problem, the parental set may be written in a PMT of a partial transport stream, which also has the parental rate descriptor as does a SIT, in addition to, or instead of, writing it in a SIT. PMTs are recorded at a higher frequency than SITs in a partial transport stream. Therefore, even in a case where a program is reproduced starting from a certain point in the middle of the program, for example, the parental set included in a PMT can be detected instantaneously.

Alternatively, the parental set may be recorded in a predetermined header section storing management data for managing a series of data on the recorded program, in addition to recording it in a SIT. Thus, it is possible to reproduce the program under a parental control by obtaining the parental set from the beginning of the reproduction of the program. Therefore, recording the parental set in the header section is more effective for the parental control in recording/reproduction operations. Note that the parental set may be recorded in an unused free area of the header section.

Now, consider a case where a program is recorded based on a method where the program recording/reproduction section 25 receives a transport stream via a digital interface (“digital I/F”) defined in a DVB standard, such as IEEE1394. In such a case, the separation section 13 supplies a transport stream decoded by the tuner 12 to the digital I/F (not shown) between the program recording/reproduction section 25 and the separation section 13. The digital I/F selects a portion of a transport stream to be recorded, i.e., a partial transport stream, and obtains the program information including the parental set from the program information memory 22. Then, the digital I/F writes the obtained program information in a SIT, and supplies the SIT to the program recording/reproduction section 25 while multiplexing it with a partial transport stream.

Thus, the program recording/reproduction section 25 performs a recording operation by recording the program information read out from the program information memory 22 along with the designated program. Therefore, if the parental set of the program information indicates that the program should be parentally blocked, the program is recorded as a parentally-blocked program. Thus, the digital broadcasting receiver of the present invention is not of a type that does not record parentally-blocked programs, but is of a type that records parentally-blocked programs with their parental sets. Note that it is typical with appliances having a recording/reproduction function that the program being recorded is outputted to a monitor terminal, etc. Thus, the program being recorded may be viewed via the monitor by a user other than the user who has instructed the recording of the program. Therefore, it is preferred that the parental control determination as described above in the first embodiment (FIG. 5 to FIG. 8) is performed even while recording a program so as to selectively block the output to the monitor from the video output section 17 and the audio output section 18.

Then, the parental control function of blocking the program from being viewed is effectuated when reproducing the program recorded on a recording medium as follows.

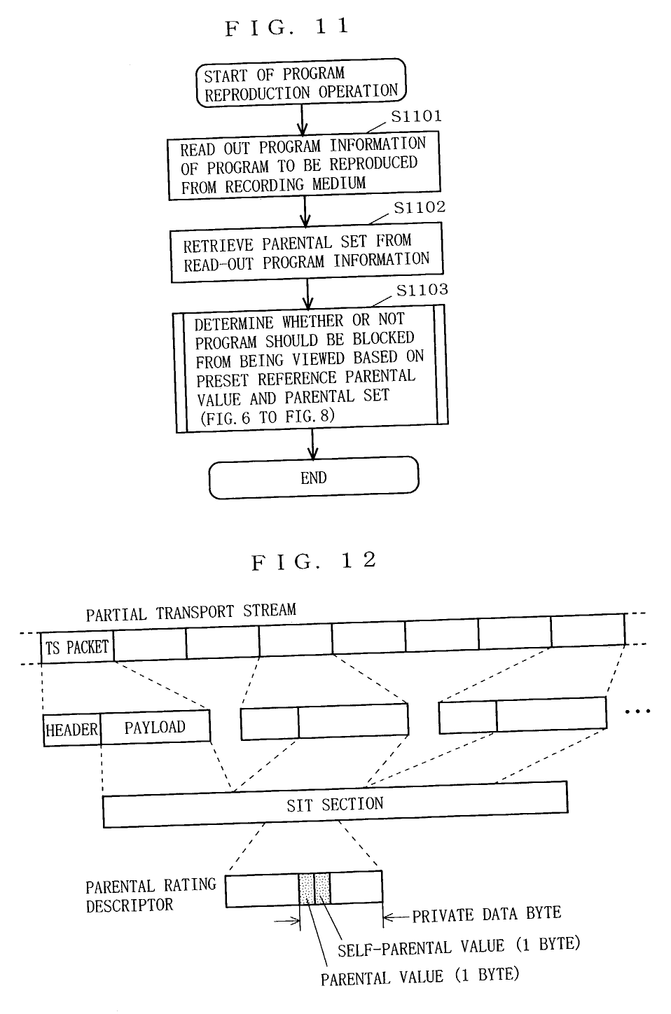

The program recording/reproduction section 25 reproduces a program designated by the user from a recording medium. FIG. 11 is a flowchart illustrating the procedure for reproducing a program.

When the user wishes to reproduce a recorded program, the user instructs the control section 20 via the user input section 19 to reproduce the program. Upon receiving the instruction to reproduce the program, the control section 20 instructs the program recording/reproduction section 25 to obtain, from the recording medium, the program information, which is recorded in the data management area of the area where the program to be reproduced is recorded. Upon receiving the instruction, the program recording/reproduction section 25 reads out and passes the program information from the recording medium to the program information management section 21 (step S1101). The program information management section 21 retrieves the parental set from the received program information, and passes it to the parental determination section 24 (step S1102). Then, the parental determination section 24 and the control section 20 make the determination as described above in the first embodiment (FIG. 6 to FIG. 8) based on the received parental set and the reference value to determine whether or not the program to be reproduced should be blocked from being viewed, i.e., whether or not the program should be blocked from being reproduced (step S1103).

When it is determined that the program should be allowed to be reproduced, the control section 20 gives predetermined instructions to relevant components so as to reproduce the program (steps S515, S525, S530, S535 and S540 in FIG. 6 to FIG. 8). When it is determined that the program should not be allowed to be reproduced, the control section 20 instructs the program recording/reproduction section 25 to stop the reproduction of the program (steps S514, S524, S529, S534 and S539 in FIG. 6 to FIG. 8). Thus, a parental control based on the parental set is realized.

A program is reproduced as follows in a case where a transport stream is received via a digital I/F as described above. Upon receiving an instruction from the control section 20 to start reproducing a program, the program recording/reproduction section 25 supplies a partial transport stream of the program to be reproduced to the separation section 13 via the digital I/F. Moreover, the program recording/reproduction section 25 supplies program information to the program information management section 21 via the digital I/F. The program information supplied to the program information management section 21 is used for parental determination. The partial transport stream supplied to the separation section 13 is processed, according to the result of the parental determination, by the separation section 13, the video decoder 14, the audio decoder 15, the synthesis section 16, the video output section 17 and the audio output section 18, and outputted to a monitor, a loudspeaker, etc.

As described above, with the digital broadcasting receiver according to the second embodiment of the present invention, the program recording/reproduction section 25 records the program information including the parental set stored in the program information memory 22 on a recording medium, together with the program. Therefore, when reproducing a program recorded by the program recording/reproduction section 25, it is possible to obtain the parental set of the program so as to reliably and easily realize a parental control that reflects the intention of the user who recorded the program.

Moreover, in the prior art, a program recorded on a recording medium can be reproduced under a parental control based on the parental value only when using the particular receiver that was used to record the program on the recording medium. In contrast, according to the present invention, parental information including the self-parental value for each recorded program is recorded on each recording medium, thereby realizing a level of compatibility that allows for a parental control based on the self-parental value with any receivers.

Note that in the second embodiment, the program recording/reproduction section 25 of the digital broadcasting receiver is used to record a program on a video cassette, or the like, for the purpose of storing the program for later viewing. However, the program recording/reproduction section 25 may also be used for the purpose of temporarily recording a program. In such a case, a digital input/output terminal may be provided, and the program recording/reproduction section 25 may be connected to an external digital recording/reproduction apparatus (e.g., a digital video cassette recorder) via the digital input/output terminal, so that a program recorded in the program recording/reproduction section 25 (in the form of a partial transport stream including SITs) can be transmitted to the external digital recording/reproduction apparatus.

(Third Embodiment)

The second embodiment is directed to a digital broadcasting receiver with which a program is recorded on a recording medium together with the parental set thereof so that the program can be blocked from being viewed even when the program is reproduced from the recording medium by using another receiver.

The third embodiment of the present invention is directed to a method for realizing useful functions such as a program searching function and a program editing function by using the parental set recorded on the recording medium.

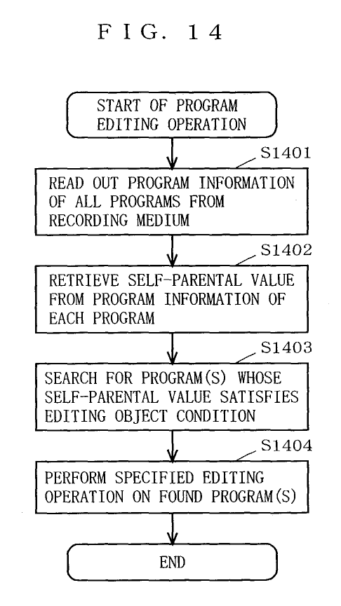

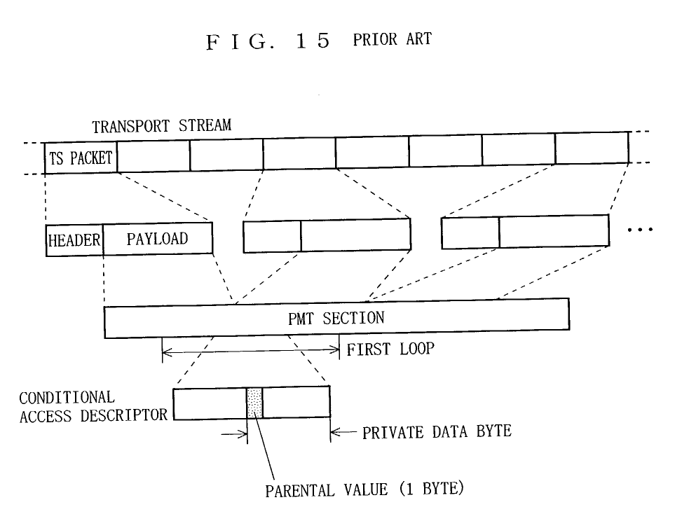

Now, the useful functions realized by the digital broadcasting receiver of the third embodiment will be described. FIG. 13 is a flowchart illustrating the procedure of the program search operation. FIG. 14 is a flowchart illustrating the procedure of the program editing operation.

1. Program Search

Referring to FIG. 13, when the user wishes to check programs recorded on a recording medium, the user instructs the control section 20 via the user input section 19 to search for programs. The user specifies a search condition indicating an attribute of the content of programs that the user wishes to search for. The search condition may be, for example, an age value or a range of age values corresponding to the parental set. For example, a search condition “18-∞” may be used to search for adult-oriented programs suitable for viewers of eighteen of age or older, and “3-15” may be used to search for child-oriented programs suitable for viewers of three to fifteen of age. Upon receiving the program searching instruction, the control section 20 instructs the program recording/reproduction section 25 to obtain, from the recording medium, the program information recorded in the data management area for all programs. Moreover, the control section 20 passes the search condition to the parental determination section 24. Upon receiving the instruction, the program recording/reproduction section 25 reads out and passes the program information for all programs from the recording medium to the program information management section 21 (step S1301). The program information management section 21 retrieves the self-parental value from each program information that it receives, and passes it to the parental determination section 24 (step S1302).

Based on the received search condition and the self-parental value of each program, the parental determination section 24 searches for programs having self-parental values that satisfy the search condition (step S1303). The information of each program that is found is passed to the control section 20. The control section 20 instructs the program information management section 21, the program information memory 22, the program list creation section 23, the synthesis section 16 and the video output section 17 to present the program information of programs found by the parental determination section 24 to the user via a monitor, or the like (step S1304). The presentation of the program information may be in the form of a program list, etc. Thus, by using the self-parental value, it is possible to easily search for programs based on an age value.

Then, the user can simply select a program to be reproduced while referring to the program information displayed on the monitor, and give an instruction to reproduce the program through the user input section 19.

Note that where a search instruction and a reproduction instruction are given at the same time, for example, the programs that satisfy the specified search condition may be automatically reproduced one after another without displaying the program information thereof on a monitor or the like. In other words, the programs on the recording medium may be reproduced while skipping those that do not satisfy the search condition. Moreover, even a program that is determined, based on the self-parental value, not to be an object of the search, may be included as an object of the search by entering a preset password. Furthermore, in order to doubly protect the program search operation, another password may be set for each program so that the program can be searched for only if the other password is entered in addition to the first password.

2. Program Editing

Referring to FIG. 14, when the user wishes to edit a program recorded on a recording medium, the user instructs the control section 20 via the user input section 19 to edit the program. The user specifies a two-part editing condition including the “editing object condition” that indicates an attribute of the content of programs that the user wishes to edit, and the “editing operation condition” that indicates the type of editing operation that the user wishes to perform on the programs. The first part of the editing condition, i.e., the editing object condition, may specify an age value or a range of age values corresponding to the parental set, and the second part, i.e., the editing operation condition, may specify a type of editing operation to be performed, e.g., copying to another recording medium or erasing. For example, an editing condition “20-∞, Erase” may be used to erase adult-oriented programs suitable for viewers of twenty of age or older, and “3-15, Copy” may be used to compile all the child-oriented programs suitable for viewers of three to fifteen of age into another recording medium. Upon receiving the program editing instruction, the control section 20 instructs the program recording/reproduction section 25 to obtain, from the recording medium, the program information recorded in the data management area for all programs. Moreover, the control section 20 passes the editing object condition of the editing condition to the parental determination section 24. Upon receiving the instruction, the program recording/reproduction section 25 reads out and passes the program information for all programs from the recording medium to the program information management section 21 (step S1401). The program information management section 21 retrieves the self-parental value from each program information that it receives, and passes it to the parental determination section 24 (step S1402).

Based on the received editing object condition and the self-parental value of each program, the parental determination section 24 searches for programs having self-parental values that satisfy the editing object condition (step S1403). The information of each program that is found is passed to the control section 20. The control section 20 instructs the program recording/reproduction section 25 to perform the editing operation specified by the editing condition on the programs that have been found in the search operation. According to the instruction from the control section 20, the program recording/reproduction section 25 erases the programs or outputs them to an external apparatus (step S1404). Thus, by using the self-parental value, it is possible to easily edit a video cassette based on an age value (e.g., to compile a video cassette containing only child-oriented programs).

Note that even those programs that are determined, based on the self-parental value, not to be the object of the editing operation, may be included as an object of the editing operation by entering a preset password. Furthermore, in order to doubly protect the program editing operation, another password may be set for each program so that the program can be edited only if this other password is entered in addition to the first password.

3. Use of Other Information

The program search operation and the program editing operation described above may be performed based on the parental information and the self-parental information in combination with other information included in the program information, e.g., genre information (that specifies the type of the content of the program, the gender to which the program is directed, etc.). The genre information is not set in the program information by broadcasting stations, but is set by the user to their preference.

The definition of the genre information and the area where the genre information is written may be arbitrarily determined by the user. In a partial transport stream, the genre information may be written in the unused bits, i.e., “0x12” to “0xFF”, of the first byte of the private data byte area that is allocated for the parental value (see FIG. 12). Alternatively, the unused bits of the one byte in the private data byte area that is allocated for the self-parental value may be used.

Various values of genre information data maybe defined as follows, for example (where * represents a wild card).

| <Data in parental value area> | <Genre> |
|---|---|
| “0 × 2*” or “0 × 3*” | Sports (baseball) |
| “0 × 4*” or “0 × 5*” | Sports (soccer) |
| “0 × 6*” or “0 × 7*” | Sports (others) |
| “0 × 8*” or “0 × 9*” | Animation (for boys) |
| “0 × A*” or “0 × B*” | Animation (for girls) |
| “0 × C*” or “0 × D*” | Drama |
| “0 × E*” or “0 × E*” | Music |

With such a definition, the user can specify a genre through a simple input operation. Thus, it is not necessary for the user to input a keyword composed of a plurality of letters such as the name of a genre as required in the prior art.

Typically, the genre information is set together with the self-parental value for each program. The genre information set by the user is stored in the program information memory 22, and is also stored in a predetermined area on a recording medium when the program is recorded.

When the user wishes to check or edit a program recorded on the recording medium, the user gives a program searching instruction or a program editing instruction to the control section 20 via the user input section 19 while specifying a search condition or an editing condition according to the defined genre information. Note that when the user wishes to be able to reproduce programs recorded on a recording medium with a plurality of receivers, the user may record, on the recording medium, information that indicates the definition of the genre information (e.g., information table), together with the genre information. Thus, other users can perform a program search operation or a program editing operation as the user who defined the genre information.

As described above, with the digital broadcasting receiver according to the third embodiment of the present invention, the user can perform a program search operation and a program editing operation under an intended viewing control by using the parental set recorded on the recording medium. Moreover, using the user-defined genre information in addition to the parental set, it is possible to realize a program search operation and a program editing operation, which are accurate and useful.

Note that while the program search operation described above in the third embodiment is performed for programs recorded on the recording medium of the program recording/reproduction section 25, it may of course also be performed for programs recorded in the program information memory 22.

While values that directly correspond to ages are used as the parental information and the self-parental information in the first to third embodiments above, user-defined arithmetic expressions or unique values may alternatively be used. A user-defined arithmetic expression may be, for example, as follows: self-parental value=parental value+(user's age×α). Moreover, a unique value “1” may be used for programs for viewers who are zero to five of age, “2” for programs for viewers who are six to ten of age, and so on. Moreover, a single unique value may represent a combination of a parental value and a self-parental value, e.g., “1” for the combination of the self-parental value “18” and the parental value “0”, “2” for the combination of the self-parental value “20” and the parental value “18”, and so on. When such unique values are used, a table representing the correspondence between various unique values and various combinations of the parental value and the self-parental value may be recorded in association with the program information.

Moreover, the digital broadcasting receiver of the present invention has been described as an apparatus capable of handling digital broadcasting signals in the first to third embodiments above. Note however that the digital broadcasting receiver of the present invention may be modified into an apparatus capable of handling analog broadcasting signals carrying no parental control information, in addition to digital broadcasting signals. Such an apparatus capable of handling both analog and digital signals can easily be realized by adding, to the digital broadcasting receiver as described above, an analog tuner for receiving analog broadcast waves, a demodulator for demodulating the analog broadcast waves into an analog signal, and an encoder for converting the analog signal into a digital signal (transport stream).

While the invention has been described in detail, the foregoing description is in all aspects illustrative and not restrictive. It is understood that numerous other modifications and variations can be devised without departing from the scope of the invention.

What is claimed is:

1. A digital broadcasting receiver for receiving and processing a digital broadcasting signal from a broadcasting station, the digital broadcasting signal being obtained by multiplexing at least a program and parental information that specifies a viewing control set by the broadcasting station for the program, the digital broadcasting receiver comprising:
a receiving section for receiving the digital broadcasting signal;
a decoding section for decoding the received digital broadcasting signal into the program and the parental information;
a user input section for receiving self-parental information entered by a user for each program, the self-parental information specifying a viewing control arbitrarily set by the user for the program;
an information storage section in which program information including the parental information and the self-parental information for each program is previously stored in association with the program, for at least some of programs that are currently being broadcast or will be broadcast;
a parental control section for determining, for each program, whether the program should be blocked from being viewed or allowed to be viewed based on reference information preset in the receiver by the user and the program information; and
a program processing section for showing or not showing the program based on the determination by the parental control section, wherein:
in response to an instruction from the user to show a received program, the parental control section obtains the program information of the received program from the information storage section, and determines whether the received program should be blocked from being viewed or allowed to be viewed based on whether or not the obtained program information satisfies the reference information; and
the program processing section shows the received and decoded program when the parental control section determines that the program should be allowed to be viewed.

2. The digital broadcasting receiver according to claim 1, wherein the parental control section determines that the received program should be allowed to be viewed if the self-parental information satisfies the reference information.

3. The digital broadcasting receiver according to claim 2, wherein where the self-parental information does not satisfy the reference information, the parental control section determines that the received program should be allowed to be viewed if the parental information satisfies the reference information.

4. The digital broadcasting receiver according to claim 1, wherein:
the parental control section determines that the received program should be allowed to be viewed if the parental information satisfies the reference information; and
where the parental information does not satisfy the reference information, the parental control section determines that the received program should be allowed to be viewed if the self-parental information satisfies the reference information.

5. The digital broadcasting receiver according to claim 2, wherein where the self-parental information does not satisfy the reference information, the parental control section prompts the user to enter a predetermined password and determines that the received program should be allowed to be viewed if the predetermined password is entered.

6. The digital broadcasting receiver according to claim 3, wherein where the parental information does not satisfy the reference information, the parental control section prompts the user to enter a predetermined password and determines that the received program should be allowed to be viewed if the predetermined password is entered.

7. The digital broadcasting receiver according to claim 4, wherein:
where the parental information does not satisfy the reference information, the parental control section prompts the user to enter a predetermined password and determines that the received program should be allowed to be viewed if the predetermined password is entered; and
where the predetermined password is not entered and the self-parental information does not satisfy the reference information, the parental control section prompts the user to input another predetermined password and determines that the received program should be allowed to be viewed if the other predetermined password is entered.

8. The digital broadcasting receiver according to claim 1, wherein where the parental information and the self-parental information are both set, the parental control section prompts the user to enter two predetermined passwords and determines that the received program should be allowed to be viewed if the two predetermined passwords are entered.

9. The digital broadcasting receiver according to claim 2, wherein the self-parental information and the reference information are each an age value determined based on an age or ages of viewers who should be allowed to view a program.

10. The digital broadcasting receiver according to claim 3, wherein the parental information, the self-parental information and the reference information are each an age value determined based on an age or ages of viewers who should be allowed to view a program.

11. The digital broadcasting receiver according to claim 4, wherein the parental information, the self-parental information and the reference information are each an age value determined based on an age or ages of viewers who should be allowed to view a program.

12. The digital broadcasting receiver according to claim 1, further comprising a program recording/reproduction section, wherein:
in response to an instruction from the user to record a program received by the receiving section, the program recording/reproduction section records, on a recording medium, the received program together with the program information for the program, which is previously stored in the information storage section; and
in response to an instruction from the user to reproduce a recorded program, the program recording/reproduction section reproduces the program information for the recorded program from the recording medium, and reproduces the recorded program from the recording medium when the parental control section determines that the recorded program should be allowed to be viewed.

13. The digital broadcasting receiver according to claim 12, wherein the program recording/reproduction section records/reproduces the program and the program information on/from a removable recording medium.

14. The digital broadcasting receiver according to claim 12, wherein the program recording/reproduction section records, on the recording medium, a partial transport stream obtained by multiplexing at least the program and the program information.

15. The digital broadcasting receiver according to claim 14, wherein the program recording/reproduction section writes the parental information and the self-parental information in at least one of a SIT and a PMT allocated in the partial transport stream.

16. The digital broadcasting receiver according to claim 15, wherein the program recording/reproduction section further records the parental information and the self-parental information in a header area on the recording medium for managing a data area where the partial transport stream is recorded.

17. The digital broadcasting receiver according to claim 14, wherein the program recording/reproduction section records an arithmetic expression for obtaining the parental information and the self-parental information in a header area on the recording medium for managing a data area where the partial transport stream is recorded.

18. The digital broadcasting receiver according to claim 12, wherein:
in response to an instruction from the user to reproduce a specific program recorded on the recording medium, the program recording/reproduction section reproduces the program information of the specific program from the recording medium;
the parental control section obtains the reproduced program information from the program recording/reproduction section, and determines whether the specific program should be blocked from being viewed or allowed to be viewed based on the program information;
the program recording/reproduction section reproduces the specific program from the recording medium when the parental control section determines that the specific program should be allowed to be viewed; and
the program processing section shows the specific program reproduced by the program recording/reproduction section.

19. The digital broadcasting receiver according to claim 12, wherein:
the user input section further receives, from the user, a search condition set by the user;
in response to an instruction from the user to search for a program recorded on the recording medium, the program recording/reproduction section reproduces from the recording medium the program information for all programs recorded thereon; and
the parental control section obtains all of the reproduced program information from the program recording/reproduction section, and searches, based on all of the program information, for a program or programs whose program information matches the search condition.

20. The digital broadcasting receiver according to claim 12, wherein:
the user input section further receives, from the user, a search condition set by the user;
in response to an instruction from the user to search for and reproduce a program recorded on the recording medium, the program recording/reproduction section reproduces from the recording medium the program information for all programs recorded thereon;
the parental control section obtains all of the reproduced program information from the program recording/reproduction section, and searches, based on all of the program information, for a program or programs whose program information matches the search condition;
the program recording/reproduction section reproduces, from the recording medium, each program found by the parental control section; and
the program processing section shows the program reproduced by the program recording/reproduction section.

21. The digital broadcasting receiver according to claim 18, wherein the parental control section determines that the reproduced program should be allowed to be viewed if the self-parental information of the reproduced program satisfies the reference information.

22. The digital broadcasting receiver according to claim 21, wherein where the self-parental information does not satisfy the reference information, the parental control section prompts the user to enter a predetermined password and determines that the reproduced program should be allowed to be viewed if the predetermined password is entered.

23. The digital broadcasting receiver according to claim 19, wherein the parental control section excludes any of the found program or programs if the self-parental information thereof does not satisfy the reference information.

24. The digital broadcasting receiver according to claim 23, wherein where the self-parental information of any found program does not satisfy the reference information, the parental control section prompts the user to enter a predetermined password and does not exclude the program if the predetermined password is entered.

25. The digital broadcasting receiver according to claim 20, wherein the parental control section excludes any of the found program or programs if the self-parental information thereof does not satisfy the reference information.

26. The digital broadcasting receiver according to claim 25, wherein where the self-parental information of any found program does not satisfy the reference information, the parental control section prompts the user to enter a predetermined password and does not exclude the program if the predetermined password is entered.

27. The digital broadcasting receiver according to claim 21, wherein the self-parental information and the reference information are each an age value determined based on an age or ages of viewers who should be allowed to view a program.

28. The digital broadcasting receiver according to claim 23, wherein the self-parental information, the reference information and the search condition are each an age value determined based on an age or ages of viewers who should be allowed to view a program.

29. The digital broadcasting receiver according to claim 25, wherein the self-parental information, the reference information and the search condition are each an age value determined based on an age or ages of viewers who should be allowed to view a program.

30. The digital broadcasting receiver according to claim 12, wherein:
the user input section further receives, from the user, predetermined information indicating a program content set by the user;
the information storage section stores the program information including the predetermined information; and
the program recording/reproduction section records the program information including the predetermined information on the recording medium.

31. The digital broadcasting receiver according to claim 30, wherein:
the user input section further receives, from the user, a search condition and a specified condition which are set by the user;
in response to an instruction from the user to search for a program recorded on the recording medium, the program recording/reproduction section reproduces from the recording medium the program information for all programs recorded thereon; and
the parental control section obtains all of the reproduced program information from the program recording/reproduction section, and searches, based on all of the program information, for a program or programs whose program information matches the search condition and the specified condition.

32. The digital broadcasting receiver according to claim 31, wherein the parental control section searches for a program or programs whose predetermined information satisfies the specified condition and whose self-parental value satisfies the reference information.

33. The digital broadcasting receiver according to claim 32, wherein where the self-parental information of a program does not satisfy the reference information, the parental control section prompts the user to enter a predetermined password and includes the program as an object of the search if the predetermined password is entered.

34. The digital broadcasting receiver according to claim 30, wherein the program recording/reproduction section records, on the recording medium, a partial transport stream obtained by multiplexing at least the program and the program information.

35. The digital broadcasting receiver according to claim 34, wherein the program recording/reproduction section writes the parental information and the self-parental information in at least one of a SIT and a PMT allocated in the partial transport stream.

36. The digital broadcasting receiver according to claim 35, wherein the predetermined information is defined in advance by using unused bits of an area where the parental information is written.

37. The digital broadcasting receiver according to claim 1, wherein:
the receiving section further has a function of receiving, from a broadcasting station, an analog broadcasting signal obtained by modulating a carrier with data concerning analog broadcast programs, and the decoding section further has a function of converting the analog broadcasting signal into a digital signal;
in the information storage section, the self-parental information obtained from the user input section for each of at least some of the analog broadcast programs that are currently being broadcast or will be broadcast is previously stored in association with the program;
in response to an instruction from the user to show an analog broadcast program, the parental control section obtains the self-parental information for the analog broadcast program from the information storage section, and determines whether the analog broadcast program should be blocked from being viewed or allowed to be viewed based on the self-parental information; and
the program processing section shows the analog broadcast program when the parental control section determines that the analog broadcast program should be allowed to be viewed.
